(19) United States
(12) Patent Application Publication
(10) Pub. No.: US 2004/0205813 A1
(43) Pub. Date: Oct. 14, 2004

(54) Method of controlling program guide display using one digital tuner, and apparatus for receiving digital broadcasting

(75) Inventor: Do-Young Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/697,801

(22) Filed: Oct. 31, 2003

(30) Foreign Application Priority Data
Apr. 11, 2003 (KR) 2003-23059

(51) Int. Cl. H04N 5/445; G06F 13/00; G06F 3/00; H04N 5/50

(52) U.S. Cl. 725/39; 348/731; 725/61; 725/52; 725/50

(57) ABSTRACT

A method of controlling program guide display using a digital tuner, and an apparatus for receiving digital broadcasting using the method are provided. In response to a command to enter an electronic program guide (EPG) mode, EPG information of N channels, which has been previously stored, is displayed. Whenever a certain channel is selected from among the displayed EPG information of N channels, the selected channel is tuned, and corresponding EPG information is updated.

### CROSS REFERENCE TO RELATED APPLICATION

This application claims the priority of Korean Patent Application No. 2003-23059, filed on 11 Apr. 2003 in the Korean Intellectual Property Office, the disclosure of which is incorporated herein in its entirety by reference.

### BACKGROUND OF THE INVENTION

1. Field of the Invention

The present invention relates to a digital TV receiving system, and more particularly, to a method of controlling an electronic program guide (EPG) display using one digital tuner, and an apparatus for receiving digital broadcasting using the method.

2. Description of the Related Art

Typically, Advanced Television System Committee (ATSC) format digital TVs or digital set top boxes selectively receive broadcast signals according to a user's channel selection and display images. As digital TVs and digital set top boxes are becoming increasingly widespread, an electronic program guide (hereinafter, referred to as EPG) has begun to be provided to allow users to use broadcast information more conveniently.

When conventional EPG broadcasting service channels transmit program information of broadcasting stations, the digital TVs or digital set top boxes decode EPG information, convert the EPG information into an on screen display (OSD) format, and then display the program information as broadcasting program information on a screen.

FIG. 1 illustrates a first example of a conventional method of controlling program guide display.

First, a TV or set top box receives broadcast signals (step 110). Then, it is checked if a user requests EPG service (step 120).

If the user requests EPG service, it is checked if all EPG information of N channels has been stored (step 130).

At this time, if all EPG information of N channels has been stored, all EPG information of N channels is displayed on a screen (step 170).

However, if all EPG information of N channels has not been stored, EPG information of channels that has not been stored is extracted from received broadcast signals (step 140). Then, it is checked if all EPG information of N channels has been stored in a memory region or another region (step 150). If all EPG information of N channels has been stored, the process returns to step 130. Otherwise, the next channel is tuned (step 160). Here, whenever the user requests EPG service, steps 140 through 160 should be repeated to obtain real-time broadcast information. Finally, if all EPG information of N channels has been stored in the memory region or another region, all EPG information of N channels is displayed on the screen (step 170).

FIG. 2 illustrates a second example of a conventional method of controlling program guide display.

First, a satellite broadcasting TV or set top box receives broadcast signals (step 210). Then, it is checked if a user requests EPG service (step 220).

If the user requests EPG service, N channels are tuned and corresponding EPG information is extracted (step 230).

Then, all of the extracted EPG information of N channels is displayed on a screen (step 240).

However, according to the conventional method of controlling program guide display of FIG. 1, since EPG information of all channels is simultaneously stored and displayed on the screen, it is impossible to provide recently updated EPG information to the user. Also, according to the conventional method of controlling program guide display of FIG. 2, all channels must be tuned so as to provide real-time EPG service to the user, which takes a considerable amount of time.

### SUMMARY OF THE INVENTION

The present invention provides a method of controlling program guide display and an apparatus for receiving digital broadcasting using the method, which maintains accurate information about a desired broadcasting channel in a digital TV or digital set top box using a digital tuner, while rapidly providing broadcast information to a user.

According to one aspect of the present invention, there is provided a method of controlling program guide display using an electronic program guide (EPG). The method comprises (a) in response to a command to enter an EPG mode, displaying EPG information of N channels, which has been previously stored, on a screen, and (b) whenever a certain channel is selected from among the displayed EPG information of N channels, tuning the selected channel and updating corresponding EPG information.

According to another aspect of the present invention, there is provided a method of controlling program guide display, in which an electronic program guide (EPG) is displayed using one tuner. The method comprises (a) in response to a command to enter an EPG mode, checking if EPG information of N channels has been stored, (b) if the EPG information of N channels has been stored, tuning a current channel and extracting corresponding EPG information, (c) displaying the EPG information of the current channel, which is extracted in step (b), and the EPG information of channels which has been previously stored, on a screen, and (d) if a certain channel is selected from among the EPG information of N channels, which is displayed in step (c), tuning the selected channel and updating corresponding EPG information.

According to yet another aspect of the present invention, there is provided an apparatus for receiving digital broadcasting which receives a transport stream incorporating EPG information. The apparatus comprises a demultiplexing unit, an image signal processing unit, an EPG generating unit, a display unit, and a control unit. The demultiplexing unit demultiplexes the transport stream into a video stream, an audio stream, and an EPG information stream. The image signal processing unit image-processes streams demultiplexed by the demultiplexing unit. The EPG generating unit generates a program guide screen using the EPG information. The display unit displays an image signal output from the image signal processing unit and the EPG information output from the EPG generating unit. The control unit tunes a current channel and detects corresponding broadcast information upon receipt of a request command of an EPG mode, tunes a channel selected from among the EPG information displayed by the display unit and updates corresponding EPG information.

### BRIEF DESCRIPTION OF THE DRAWINGS

The foregoing and other aspects and advantages of the present invention will become more apparent by describing in detail an exemplary embodiment thereof with reference to the attached drawings in which:

FIG. 1 illustrates a first example of a conventional method of controlling program guide display;

FIG. 2 illustrates a second example of a conventional method of controlling program guide display;

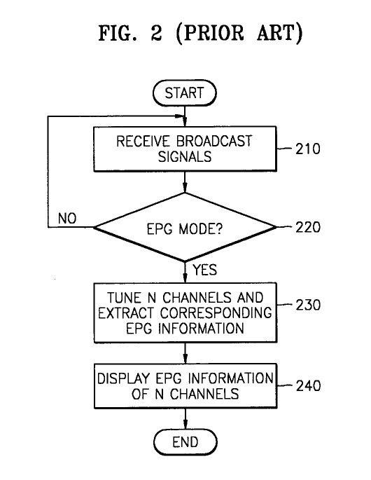

FIG. 3 is a block diagram of an apparatus for receiving digital broadcasting using a method of controlling program guide display according to the present invention;

FIG. 4 is a flowchart showing a method of controlling program guide display according to the present invention; and

FIG. 5 illustrates an EPG displayed on a screen when a user requests an EPG mode, according to the present invention.

### DETAILED DESCRIPTION OF THE INVENTION

The present invention will now be described more fully with reference to the accompanying drawings, in which a preferred embodiment of the invention is shown.

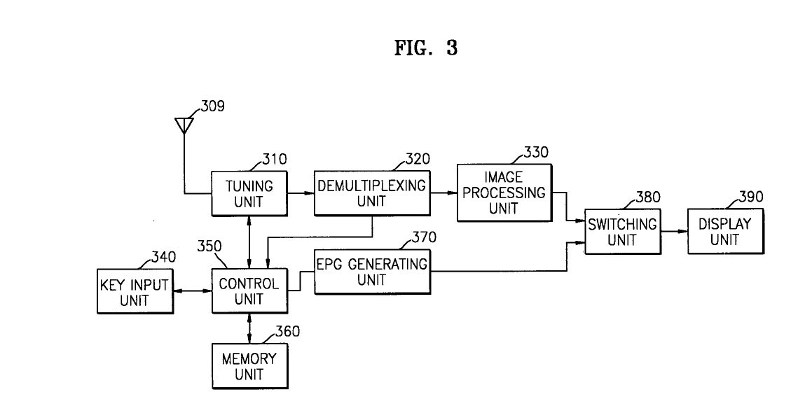

FIG. 3 is a block diagram of an apparatus for receiving digital broadcasting using a method of controlling program guide display according to the present invention. Such an apparatus, for purposes of illustrative example, and not by way of limitation, may include, or be logically connected with, a television set, including for example a television set using a CRT display, a rear or front projector, an LCD or plasma display or the like, or some combination of the foregoing. The types of display suitable to be used with the present invention will be readily understood and will not be explained in detail.

Referring to FIG. 3, a tuning unit 310 tunes broadcast signals that are input from an antenna 309 in a transport stream format. The broadcast signals incorporate EPG information of each of a plurality of channels.

A demultiplexing unit 320 demultiplexes the broadcast signals tuned by the tuning unit 310, i.e., the transport stream, into video, audio, and EPG information.

An image signal processing unit 330 decodes a video stream, which is demultiplexed by the demultiplexing unit 320, into an original image signal.

An EPG generating unit 370 generates program guide display of an OSD format by using information related to program guide such as EPG that is extracted from a control unit 350.

A switching unit 380 selectively switches between the image signal output from the image signal processing unit 330 or an EPG signal output from the EPG generating unit 370.

A display unit 390 displays the image signal or EPG signal output from the switching unit 380 on a screen.

The control unit 350 controls the operation of each unit, stores EPG information demultiplexed by the demultiplexing unit 320 in a memory unit 360, reads the EPG information stored in the memory unit 360 in response to a command to enter an EPG mode received from a key input unit 340, and transmits the EPG information to the EPG generating unit 370. In particular, upon receiving the command to enter the EPG mode from the key input unit 340, the control unit 350 tunes a current channel (a channel in which the user executes the EPG mode), detects corresponding broadcast information, and updates EPG information of a channel selected by the key input unit 340 from among EPG information displayed on the screen.

The memory unit 360 stores the EPG information demultiplexed by the demultiplexing unit 320 through control of the control unit 350.

The key input unit 340 receives the command to enter the EPG mode and commands of operation modes from the user and transmits those commands to the control unit 350. In particular, the key input unit 340 includes direction keys for selecting a desired channel from among EPG information displayed on the screen.

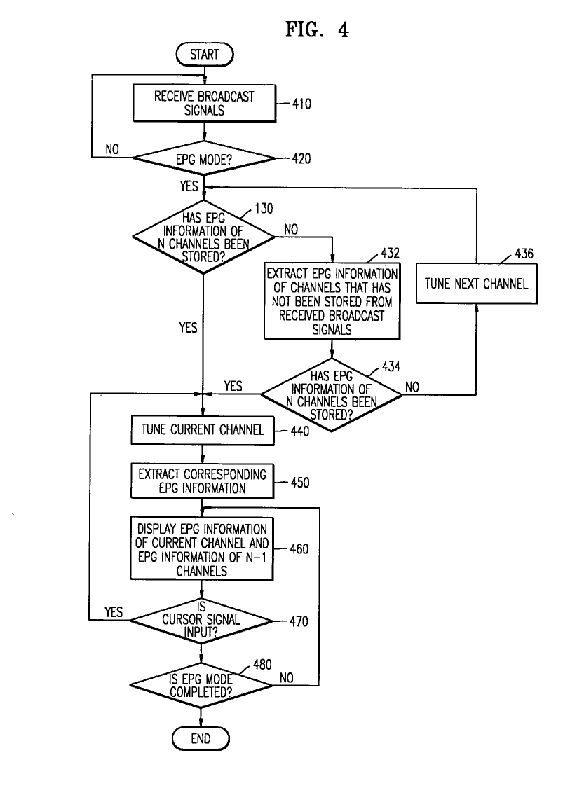

FIG. 4 is a flowchart showing a method of controlling program guide display according to the present invention.

First, broadcast signals input in a transport stream format are received (step 410). At this time, it is checked if a user requests EPG service (step 420). Here, EPG information includes a system time table (STT), a master guide table (MGT), a virtual channel table (VCT), a rating region table (RRT), and/or an event information table (EIT), according to program and system information protocol (PSIP).

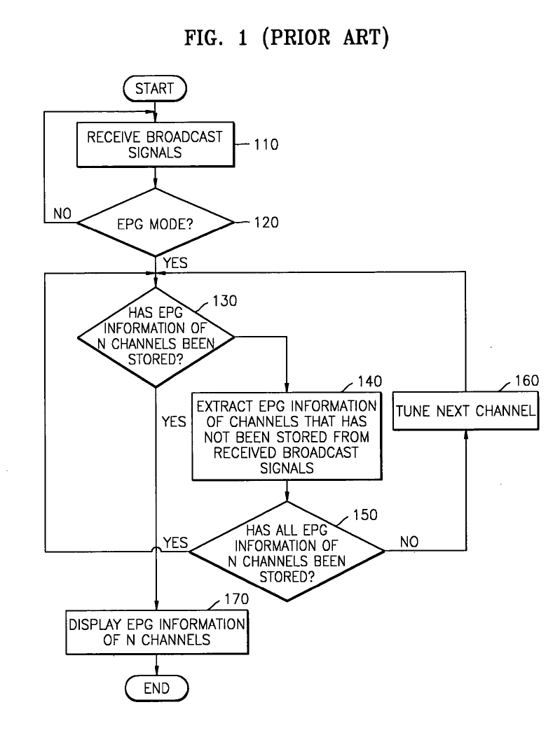

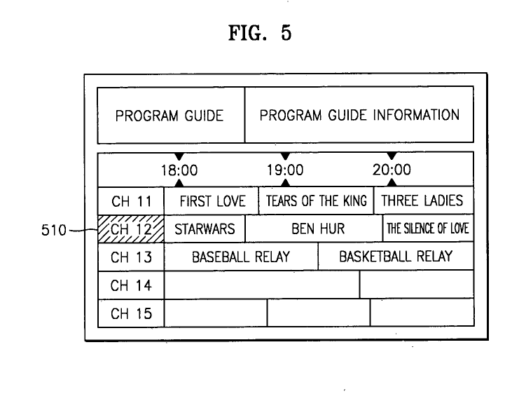

If the user requests EPG service, it is checked whether EPG information of N channels has already been stored based on the event information table (EIT) stored in the memory unit 360 (step 430). Here, the EIT and the VCT of the received broadcast signals are stored in the memory unit 360. If EPG information of N channels has not been stored, EPG information of channels that has not been stored is extracted from the received broadcast signals according to steps 432, 434, and 436 in the same manner as the conventional method of controlling program guide display (steps 140, 150, and 160 of FIG. 1). For example, in FIG. 5, channels CH 14 and CH 15 are tuned, thus extracting corresponding EPG information.

If EPG information of N channels has already been stored, a current channel (a channel in which the user executes the EPG mode) is tuned (step 440) and corresponding EPG information is extracted (step 450). Thus, most recent broadcast information of the current channel is extracted. According to a preferred embodiment, if the user executes the EPG mode in a channel in which broadcast signals have not been received, the current channel is set to the smallest channel number.

Next, EPG information of the current channel and EPG information of N-1 channels that has been previously stored is displayed on the screen (step 460). According to a preferred embodiment, a cursor is positioned at broadcasting programs of a current channel in a graphic EPG screen. Thus, as shown in FIG. 5, the EPG screen is displayed in which a cursor 510 is positioned at broadcasting programs of the current channel.

Next, it is checked if a cursor signal for selecting EPG information of another channel is input from the key input unit 340 (step 470). In other words, if it is determined that the user moves the cursor, it is determined whether the cursor moves vertically or horizontally.

If it is determined that the cursor signal moves to another channel, the process returns to step 440 to tune a channel corresponding to EPG information of the selected channel. For example, in FIG. 5, if the user selects channel CH 12, EPG information of the selected channel CH 12 is tuned. As a result, only the channel that the user selects is tuned, and updated EPG information is displayed on a screen. Also, the user can be quickly provided with accurate information about a desired channel.

Finally, program guide display is controlled until the EPG mode is completed by the key input unit 340 (step 480).

The present invention may be embodied as computer readable code on a computer readable recording medium or may be implemented as hardware, firmware or the like, or some combination of the foregoing. The computer readable recording medium may be, but is not limited to, ROM, RAM, CD-ROM, a magnetic tape, a hard disk, a floppy disk, flash memory, an optical data storage medium, and carrier waves (e.g., transmissions over the Internet). In addition, the computer readable recording medium may be distributed over computer systems connected via a network, and stored and implemented as a computer readable code using a distribution technique.

As described above, according to the present invention, it is possible to maintain accurate information about broadcasting channels in a digital TV or digital set top box using one digital tuner, while rapidly providing the user with broadcast information.

While the present invention has been particularly shown and described with reference to an exemplary embodiment thereof, it will be understood by those of ordinary skill in the art that various changes in form and details may be made therein without departing from the spirit and scope of the invention as defined by the appended claims and their equivalents.

What is claimed is:

1. A method of controlling a program guide display using an electronic program guide (EPG), the method comprising:
(a) in response to a command to enter an EPG mode, displaying EPG information of N channels, which EPG information has been previously stored; and
(b) whenever a selection channel is selected from among the N channels for which the EPG information is displayed, tuning the selection channel and updating corresponding EPG information.

2. The method of claim 1, wherein operation (a) further comprises tuning a channel of the N channels for which the entry of the EPG mode is requested, and displaying updated EPG information.

3. A method of controlling a program guide display in which an electronic program guide (EPG) is displayed using one tuner, the method comprising:
(a) in response to a command to enter an EPG mode, checking if EPG information of N channels has been stored;
(b) if the EPG information of N channels has been stored, tuning a current channel of the N channels and extracting corresponding EPG information;
(c) displaying the EPG information of the current channel, which is extracted in operation (b), and the EPG information of remaining channels of the N channels which has been previously stored; and
(d) if a selection channel is selected from among the N channels for which the EPG information of N channels is displayed in operation (c), tuning the selected channel and updating corresponding EPG information.

4. The method of claim 3, wherein, in operation (c), the updated EPG information of the current channel and the EPG information of N-1 channels of the EPG information of the N channels which has been previously stored, is displayed.

5. The method of claim 3, wherein, in operation (d), the selection channel is selected by positioning a cursor at a broadcasting program of a current channel while an EPG information screen is displayed, determining whether the cursor moves, and if the cursor moves, determining whether the cursor moves vertically or horizontally.

6. An apparatus configured to receive digital broadcasting, tne apparatus receiving a transport stream incorporating EPG information, the apparatus comprising:
a demultiplexing unit configured to demultiplex the transport stream into a video stream, an audio stream, and the transport stream incorporating EPG information;
an image signal processing unit configured to image-process streams demultiplexed by said demultiplexing unit;
an EPG generating unit configured to generate a program guide screen using the EPG information;
a display unit configured to display an image signal output from said image signal processing unit and the EPG information output from said EPG generating unit; and
a control unit configured to tune a current channel and to detect corresponding broadcast information upon receipt of a request command of an EPG mode, to tune a channel selected from among channels for which the EPG information is displayed by said display unit, and then to update EPG information corresponding to the selected channel.

7. The apparatus of claim 6, further comprising a key input unit configured to select a desired channel from among the channels for which EPG information is displayed.
